(19) United States
(12) Patent Application Publication
(10) Pub. No.: US 2025/0326154 A1
(43) Pub. Date: Oct. 23, 2025

(54) COMPOSITE WOOD STRUCTURES AND METHODS FOR FABRICATING THE SAME

(71) Applicant: West Virginia University Board of Governors on Behalf of West Virginia University, Morgantown, WV (US)

(72) Inventors: Hota GangaRao, Morgantown, WV (US); Rakesh Gupta, Morgantown, WV (US); Chao Zhang, Morgantown, WV (US)

(21) Appl. No.: 19/182,141

(22) Filed: Apr. 17, 2025

Related U.S. Application Data
(60) Provisional application No. 63/635,314, filed on Apr. 17, 2024.

(51) Int. Cl. B27N 3/00; B27N 3/02

(52) U.S. Cl. CPC B27N 3/002; B27N 3/02

(57) ABSTRACT

Composite wood structures and methods for fabricating the same are provided. A wooden body is structurally improved through polymeric resin infusion involving in situ resin synthesis that forms an interpenetrating polymer network (IPN) and reduces moisture content in the wooden body. Moisture reduction effectuated by in situ synthesis can reduce the extent to which the wooden body needs to be dried prior to resin infusion. Fiber-reinforced polymers can be applied to the resin-infused wooden body to further improve its strength characteristics. Low-grade wooden bodies, such as lumber with a low commercial-grade rating or an aggregate of wooden particulate which are commonly discarded as waste or used as fuel, can be structurally upgraded and repurposed as a higher value-added product through resin infusion.

### CROSS-REFERENCE TO RELATED APPLICATION

The present application claims priority to U.S. Provisional Patent Application Ser. No. 63/635,314, filed Apr. 17, 2024, the entire disclosure of which is incorporated herein by reference.

### TECHNICAL FIELD

The presently disclosed subject matter generally relates to composite wood structures and methods for fabricating the same. In particular, certain embodiments of the presently disclosed subject matter relate to composite wood structures which include a wooden body infused with a polymeric resin synthesized in situ within the wooden body.

### BACKGROUND

Lumber has a high strength-to-weight ratio. Lumber can carry its own weight plus a high percent (˜65 to 70%) of remaining design stress to resist live, wind, and seismic loads including high degree of damping. However, lumber has certain inherent limitations including dimensional changes due to: varying moisture content, insect and fungal attacks at high moisture levels (>20%); checks, knots, and splits leading to local stress concentrations; fire susceptibility; and others. Due to nature's vagaries, volumetric yields of sawn lumber are about 55%, out of which only 10% can be used for very high-grade furniture manufacturing quality lumber. The rest (˜45%) goes to landfills as waste or is used as fuel. Furthermore, Young's modulus and the modulus of rupture for corewood, respectively, are about 30% and 41% lower than the outerwood, also known as sap excluding bark. In oak logs, for example, only 8% to 9% of the yield results in quality grade lumber that is useful as structural-grade wood products (e.g., beam) because of wanes and biotic damages.

### SUMMARY

The presently disclosed subject matter meets some or all of the above-identified limitations, as will become evident to those of ordinary skill in the art after a study of information provided in this document.

This summary describes several embodiments of the presently disclosed subject matter, and in many cases lists variations and permutations of these embodiments. This summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently disclosed subject matter, whether listed in this summary or not. To avoid excessive repetition, this summary does not list or suggest all possible combinations of such features.

A composite wood structure made in accordance with the present disclosure includes a wooden body infused with a polymeric resin that forms a heterogeneous interpenetrating polymer network (IPN) with native polymers of the wooden body. In some embodiments, the IPN comprises a first polymer network defined by the polymeric resin and a second polymer network defined by the native polymers of the wooden body, where the first polymer network is covalently linked to the second polymer network. In some embodiments, the polymeric resin is a cross-linked polymeric resin. In some embodiments, the polymeric resin comprises polyurethane. In some embodiments, the composite wood structure comprises about 5 wt % to about 40 wt % polymeric resin. In some embodiments, the polymeric resin partially or completely fills one or more voids present within the wooden body.

In some embodiments, infusion of the polymeric resin is facilitated, at least in part, via in situ resin synthesis within the wooden body utilizing precursors for the polymeric resin, which, when introduced into the wooden body, invokes (i) a reaction that forms the IPN between the polymeric resin and the native polymers of the wooden body and (ii) hydroxyl molecule bonding with water molecules present in the wooden body that reduces the moisture content of the wooden body. In some embodiments, the wooden body is further infused with a product formed by a reaction between an intermediate and a first monomeric precursor to the polymeric resin, where the intermediate is formed as a result of a reaction between a second monomeric precursor to the polymeric resin and a hydroxyl group of a water molecule from the wooden body. In some embodiments, such a product has a higher thermal stability than the polymeric resin. In some embodiments, the product is urea.

In some embodiments, the wooden body is a low-grade wooden body. In some embodiments, the wooden body is a piece of lumber having a commercial-grade rating of lower than No. 2 or No. 2B prior to being infused with the polymeric resin. In some embodiments, the wooden body is an aggregate of wood particulate. In some embodiments, the wood particulate is woodchips. In some embodiments, the wood particulate is sawdust.

In some embodiments, the composite wood structure further comprises a fiber-reinforced polymer (FRP) applied to the wooden body infused with the polymeric resin. In some embodiments, the composite wood structure including the FRP has a flexural strength of at least 9,000 pounds per square inch (psi).

In some embodiments, the composite wood structure has a commercial-grade rating of (i) No. 2 or higher or (ii) No. 2B or higher.

Further provided are methods for fabricating composite wood structures. In some implementations, a method for fabricating a composite wood structure includes infusing a wooden body with a polymeric; and curing the resin-infused wooden body, where infusing the wooden body with the polymeric resin reduces the moisture content of the wooden body.

In some implementations, infusing the wooden body with the polymeric resin includes synthesizing the polymeric resin in situ within the wooden body. In some implementations, infusing the wooden body with the polymeric resin includes: mixing a first, monomeric precursor of the polymeric resin with a second precursor of the polymeric resin to form a mixture; and applying the mixture to the wooden body under pressure to introduce the first, monomeric precursor and the second precursor of the polymeric resin into the wooden body to promote synthesis of the polymeric resin. In some implementations, the first, monomeric precursor is hydroxyl-reactive. In some implementations, the first, monomeric precursor of the polymeric resin is an isocyanate. In some embodiments, the second precursor of the polymeric resin is polyol. In some implementations, the polymeric resin is polyurethane. In some implementations, an IPN is formed between the polymeric resin and native polymers of the wooden body.

In some implementations, a method for fabricating a composite wood structure further includes drying the wooden body prior to infusing the polymeric resin, such that the moisture content of the wooden body is greater than 18% following drying. In some implementations, the moisture content of the wooden body is reduced to between 8% to 18% following infusing of the polymeric resin.

In some implementations, a method for fabricating a composite wood structure further includes applying a FRP to the resin-infused wooden body subsequent to curing the resin-infused wooden body. In some implementations, applying the FRP to the resin-infused wooden body includes encapsulating the resin-infused wooden body with the FRP.

In some implementations, the wooden body is a low-grade wooden body. In some implementations, the wooden body is a piece of lumber having a commercial-grade rating of lower than No. 2 or No. 2B prior to being infused with the polymeric resin. In some implementations, the wooden body is an aggregate of wood particulate. In some implementations, the wood particulate is woodchips. In some implementations, the wood particulate is sawdust.

### BRIEF DESCRIPTION OF THE DRAWINGS

A better understanding of the features and advantages of the present invention will be obtained by reference to the following detailed description that sets forth illustrative embodiments, in which the principles of the invention are used, and the accompanying drawings of which:

FIG. 1 is a schematic representation of an embodiment of a composite wood structure made in accordance with the present disclosure.

FIG. 2 is a schematic cross-sectional view of the composite wood structure of FIG. 1 taken along line 2-2 in FIG. 1.

FIG. 3 is a schematic representation of hydroxyl groups provided on the surfaces of native polymers of a wooden body.

FIG. 4 is a schematic representation of hydroxyl groups provided on the surfaces of native polymers of a wooden body similar to FIG. 3, but with water molecules bound to certain hydroxyl groups of the native polymers.

FIG. 5 shows a diisocyanate with a urea linkage, where R′ is an organic moiety.

FIG. 6 is a reaction scheme showing an exemplary synthesis of polyurethane, where R and R′ are organic moieties.

FIG. 7 is a schematic representation of another embodiment of a composite wood structure made in accordance with the present disclosure.

FIG. 8 is a magnified schematic cross-sectional view of the composite wood structure of FIG. 7 taken along line 8-8 in FIG. 7.

FIG. 9 is a schematic representation of another embodiment of a composite wood structure made in accordance with the present disclosure.

FIG. 10 is a schematic cross-sectional view of the composite wood structure of FIG. 9 taken along line 10-10 in FIG. 9.

FIG. 11 is a flowchart showing an implementation of a method for fabricating a composite wood structure in accordance with the present disclosure.

FIG. 12A is an image showing an untreated low-grade wood sample (Grade No. 4) in the form of a piece of southern yellow pine lumber.

FIG. 12B is another image showing the low-grade wood sample of FIG. 12A, but treated with resin infusion to form a composite wood structure in accordance with the present disclosure.

FIG. 13A is an image showing an untreated low-grade wood sample (below Grade No. 2) in the form of another piece of southern yellow pine lumber.

FIG. 13B is another image showing the low-grade wood sample of FIG. 13A, but incised and treated with resin infusion to form a composite wood structure in accordance with the present disclosure.

FIG. 14 is a chart comparing the stress versus strain of the untreated wood sample of FIG. 12A, the treated wood sample of FIG. 12B, and an untreated high-grade wood sample in the form of a piece of red oak lumber.

FIG. 15 is a chart comparting the flexural strength (three-point bend test) of the untreated wood sample of FIG. 12A, the treated wood sample of FIG. 12B, and an untreated high-grade wood sample in the form of a piece of red oak lumber.

FIG. 16 is a bar chart comparing the load versus displacement comparing an untreated low-grade southern yellow pine lumber sample (identified as “Natural Sample”), a composite wood structure comprised of a low-grade southern yellow pine lumber sample infused with polymeric resin with 1% methyl ethyl ketone peroxide (MEKP) catalyst (identified as “1% MEKP”), a composite wood structure comprised of a low-grade southern yellow pine lumber sample infused with polymeric resin with 2% MEKP catalyst (identified as “2% MEKP”), a composite wood structure comprised of a low-grade southern yellow pine lumber sample infused with polymeric resin with 3% MEKP catalyst (identified as “3% MEKP”), and a composite wood structure comprised of a low-grade southern yellow pine lumber sample infused with polymeric resin with 3% MEKP catalyst and treated with benzyl alcohol (identified as “3% MEKP w/ Treatment”).

FIG. 17 is an image showing a composite wood structure comprised of an aggregate of woodchips infused with a polymeric resin and compressed during curing.

FIG. 18 is an image showing a fiber reinforced polymer (FRP) being applied to the aggregate of woodchips infused with a polymeric resin of FIG. 17 via vacuum-assisted resin transfer molding (VARTM).

FIG. 19 is an image showing a composite wood structure comprised of an aggregate of wood chips infused with a polymeric resin and a FRP.

FIG. 20 is a chart comparing the stress versus strain of the composite wood structure of FIG. 17 (identified as “Unwrapped woodchip”) and the composite wood structure of FIG. 19 (identified as “Wrapped woodchip”).

FIG. 21 is a chart comparing the flexural strength (three-point bend test) of the composite wood structure of FIG. 17 (identified as “Unwrapped woodchip”) and the composite wood structure of FIG. 19 (identified as “Wrapped woodchip”).

FIG. 22 is an image showing a composite wood structure in accordance with the present disclosure comprised of an aggregate of sawdust infused with a polymeric resin.

FIG. 23 is an image showing a FRP wrap being applied to the aggregate of sawdust infused with a polymeric resin of FIG. 22 via VARTM.

FIG. 24 is an image showing a composite wood structure in accordance with the present disclosure comprised of an aggregate of sawdust infused with a polymeric resin and a FRP.

FIG. 25 is a chart comparing stress versus strain of the composite wood structure of FIG. 22 (identified as “Unwrapped sawdust”) and the composite wood structure of FIG. 24 (identified as “Wrapped sawdust”).

FIG. 26 is a chart comparing the flexural strength (three-point bend test) of the composite wood structure of FIG. 22 (identified as “Unwrapped sawdust”) and the composite wood structure of FIG. 24 (identified as “Wrapped sawdust”).

### DESCRIPTION OF EXEMPLARY EMBODIMENTS

The details of one or more embodiments of the presently disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

While the terms used herein are believed to be well understood by those of ordinary skill in the art, certain definitions are set forth to facilitate explanation of the presently disclosed subject matter.

Unless defined otherwise, all technical and scientific terms used herein have the same meaning as is commonly understood by one of skill in the art to which the invention(s) belong. All patents, patent applications, published applications and publications, databases, websites and other published materials referred to throughout the entire disclosure herein, unless noted otherwise, are incorporated by reference in their entirety. Where reference is made to a URL or other such identifier or address, it is understood that such identifiers can change and particular information on the internet can come and go, but equivalent information can be found by searching the internet. Reference thereto evidences the availability and public dissemination of such information.

Although any methods, devices, and materials similar or equivalent to those described herein can be used in the practice or testing of the presently disclosed subject matter, representative methods, devices, and materials are described herein.

The present application can “comprise” (open ended) or “consist essentially of” the components of the present invention as well as other ingredients or elements described herein. As used herein, “comprising” is open ended and means the elements recited, or their equivalent in structure or function, plus any other element or elements which are not recited. The terms “having” and “including” are also to be construed as open ended unless the context suggests otherwise.

Following long-standing patent law convention, the terms “a”, “an”, and “the” refer to “one or more” when used in this application, including the claims. Thus, for example, reference to “a monomer” can include a plurality of such monomers, and so forth.

Unless otherwise indicated, all numbers expressing quantities of ingredients, properties such as reaction conditions, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently disclosed subject matter.

As used herein, the term “about,” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, in some embodiments ±0.1%, in some embodiments ±0.01%, and in some embodiments ±0.001% from the specified amount, as such variations are appropriate to perform the disclosed method.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that where a range of units is disclosed, such range is inclusive of the starting and end units. For example if a range of “10 to 15” or “between 10 to 15” is disclosed, then 10 and 15 are considered part of such range, unless stated otherwise. It is also understood that each unit between two particular units are also disclosed. For example, if 10 and 15 are disclosed, then 11, 12, 13, and 14 are also disclosed.

The presently disclosed subject matter is based, in part, on the discovery that wooden materials that are commonly discarded as waste or are used for fuel (i.e., wood waste materials) can be transformed into composite wood structures which can be utilized in various construction or other commercial applications by upgrading the mechanical properties of such materials through resin infusion involving in situ resin synthesis. In this regard, it has been surprisingly discovered that the introduction of resin precursors into wood waste materials invokes (i) a reaction that promotes the formation of an interpenetrating polymer network (IPN) between a polymeric resin and native polymers (e.g., cellulose, hemicellulose, and lignin) of the wood waste material, and (ii) hydroxyl (—OH) molecule bonding (water consumption) that reduces the moisture content of the wood waste material. The mechanical properties of the resulting resin-infused wooden material (i.e., the resulting composite wood structure) are then significantly improved relative to that of the wood waste material prior to resin infusion, thus better enabling the wood waste material to be repurposed and reused in various construction or other commercial applications.

Accordingly, the present disclosure includes composite wood structures and methods for making the same. In particular, embodiments of the present disclosure include composite wood structures and methods of fabricating the same which make use of low-grade wooden bodies that are structurally upgraded through polymer resin infusion. As will become evident by the discussion which follows, the composite wood structures and methods disclosed herein can serve to reduce waste produced by and/or the energy consumption involved in various wood processing and/or construction operations.

As used herein, the term “wooden body” refers to a wooden material or an aggregate of wooden materials which can be infused with a polymeric resin in the same or similar fashion as disclosed herein. The term, in the absence of any characterization regarding grading, is inclusive of both low-grade wooden bodies and high-grade wooden bodies. In various embodiments, a wooden body is in the form of a piece of hardwood lumber, a piece of softwood lumber, or an aggregate of wood particulate created by the processing of larger pieces of wood.

As used herein, the term “low-grade wooden body” refers to a wooden body in the form of a piece of lumber which has, or possesses structural features which would cause the lumber to receive, a commercial-grade rating lower than No. 2 (for softwood lumber) or No. 2B (for hardwood lumber), or to a wooden body in the form of an aggregate of wood particulate created by the processing of larger pieces of wood. In some embodiments, the wood particulate making up the aggregate of wood particulate includes sawdust, wood chips, or combinations thereof. In some instances, a low-grade wooden body can correspond to a piece of wood or an aggregate of wood particulate that, without structural modification, has limited structural integrity and strength, rendering it unideal for structural building applications.

A wooden substrate which is not a low-grade wooden body can be characterized as a “high-grade wooden body.” In various embodiments, a high-grade wooden body can be in the form of a hardwood or softwood piece of lumber having a commercial-grade rating of No. 2B or 2, respectively, or higher.

With respect to the commercial-grade rating of lumber, it is appreciated that a lower commercial-grade rating corresponds to a lower quality of lumber as opposed to a smaller numeric rating value. For instance, a lower commercial-grade rating lower than No. 2 for softwood lumber can be No. 3 or No. 4, and a lower commercial-grade rating than No. 2B for hardwood lumber can be No. 3A or No. 3B. Conversely, a higher commercial-grade rating than No. 3 for softwood lumber can be No. 2 or No. 1, and a higher commercial-grade rating than No. 3A for hardwood lumber can be No. 2A or No. 2B. Commercial-grade ratings for lumber, both softwood and hardwood, and the standards for assessing the same are known within the art. In some embodiments, commercial-grade rating of lumber can be performed from a structural standpoint in accordance with the National Design Specification (NDS) Published by the American Wood Council. In some embodiments, commercial-grade rating of lumber can be performed from a visual standpoint in accordance with grading rules set forth by the Western Wood Products Association (WWPA).

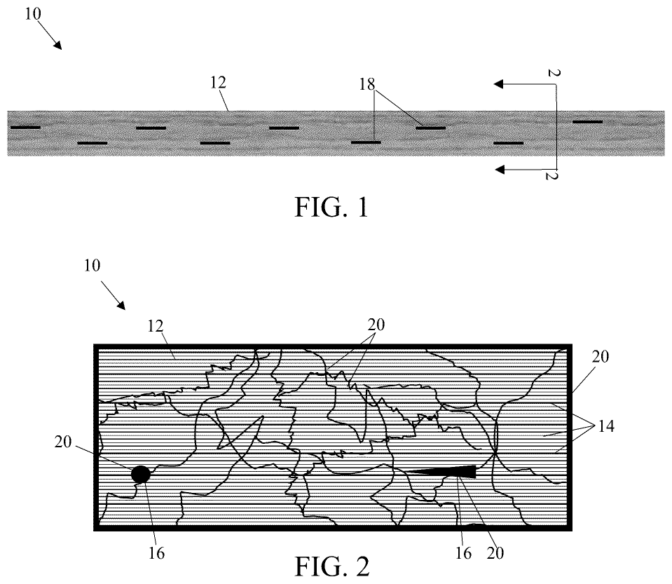

Referring first to FIGS. 1 and 2, a composite wood structure 10 made in accordance with an embodiment of the present disclosure is provided. The composite wood structure 10 includes a low-grade wooden body 12 that is infused with a polymeric resin 20, such that the interior molecular structure of the low-grade wooden body 12 is modified relative to its native state. More specifically, in this embodiment, the polymeric resin 20 has penetrated into the native molecular structure of the low-grade wooden body 12 and formed a sequential, heterogeneous IPN therewith. That is, the polymeric resin 20 defines a first polymer network that is interlaced with a second polymer network defined by native polymers 14 (cellulose, hemicellulose, and/or lignin) present in the low-grade wooden body 12. In some embodiments, the native polymers 14 of the low-grade wooden body 12, aside from any effect resulting from the cutting or drying of the low-grade wooden body 12 or the wood particulates thereof, are not artificially altered, such as by chemical treatment (e.g., chemical-induced delignification) or radiation-based treatment, prior to the low-grade wooden body being infused with the polymeric resin 20.

In FIG. 2, the native polymers 14 of the low-grade wooden body 12 are generically represented by horizontal lines while the polymeric resin 20 is generically represented by the lines intersecting such horizontal lines for ease in illustration. As such, it will be appreciated that the composite wood structure 10 is not limited to the specific construction shown in FIGS. 1 and 2. Accordingly, the assumed shape, distribution, amount, proportion of the native polymers 14 and the polymeric resin 20 in the composite wood structure 10 can vary from that shown in FIGS. 1 and 2 without departing form the spirit and scope of the present disclosure.

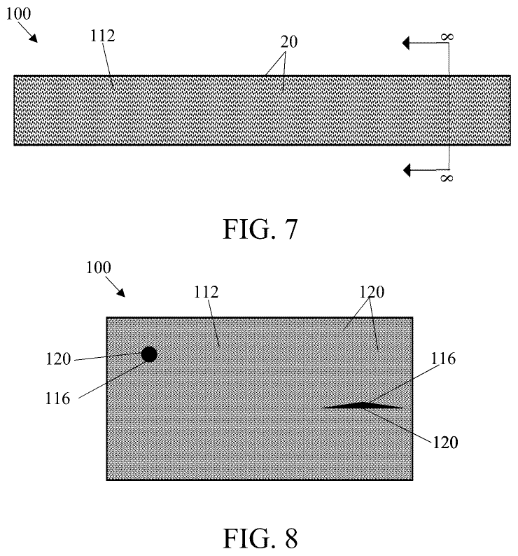

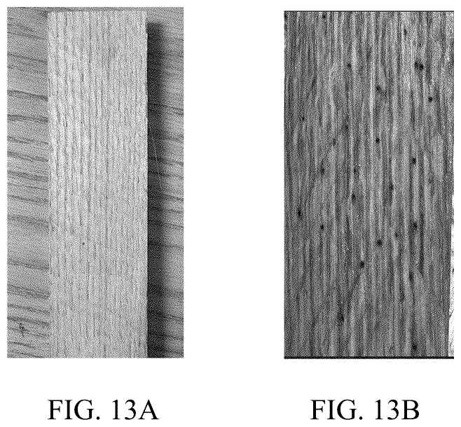

Various types and species of wood material can be utilized for the low-grade wooden body 12. In the embodiment shown in FIGS. 1 and 2, the low-grade wooden body 12 is in the form of a piece of lumber. Lumber which can be utilized as the low-grade wooden body 12 in various embodiments of the composite wood structure 10 include lumber sourced from angiosperm trees (hardwoods) and lumber sourced from gymnosperm trees (softwoods). Hardwood lumber which can be utilized in various embodiments include, but is not necessarily limited to, oak, maple, cherry, walnut, birch, hickory, balsa, and poplar species. For instance, in some embodiments, the low-grade wooden body is a piece of red oak lumber having a commercial-grade rating of 3 A or lower. Softwood lumber which can be utilized in various embodiments include, but is not necessarily limited to, pine, spruce, fir, cedar, and larch species. For instance, in some embodiments, the low-grade wooden body 12 is a piece of southern yellow pine or Douglas fir having a commercial-grade rating of 3 or lower (FIGS. 12A, 12B, 13A, and 13B). As will become further evident in the discussion of the composite wood structures 100, 200 described below with reference to FIGS. 7-10, in some embodiments, instead of lumber, the low-grade wooden body 12 is in the form of an aggregate of wooden particulate, such as sawdust or woodchips, produced during the processing of larger pieces of wood.

The dimensions of the low-grade wooden body 12 utilized in the construction of the composite wood structure 10 can be sized to accommodate different applications and environments. For instance, in some embodiments, for small-scale construction projects, the low-grade wooden body 12 can have a length (l) ranging between 4″ (4 inches) and 16″ and a cross-section ranging between 3″ width (w)×1″ height (h) and 2″w×0.5″h. In some embodiments, the low-grade wooden body 12 can have dimensions consistent with that of standard-sized lumber. For instance, in some embodiments, the low-grade wooden body 12 can have dimensions of about 1″w×6″h×20′l (20 feet). In some embodiments, the low-grade wooden body 12 can have dimensions consistent with that commonly utilized for railway ties. For instance, in some embodiments, the low-grade wooden body 12 can have dimensions of about 10″w×12″h×10′l. The dimensions of the composite wood structure 10 will typically be largely consistent with that of the low-grade wooden body 12.

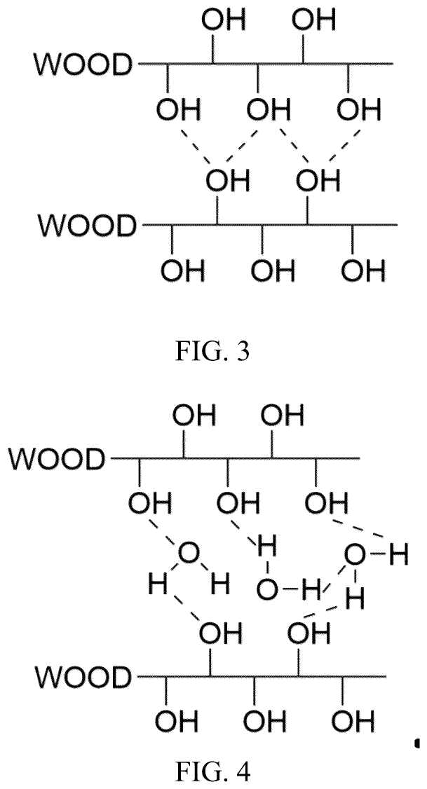

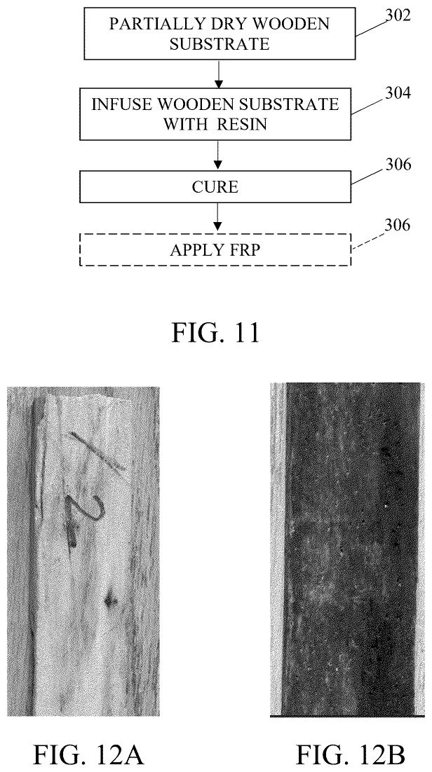

Referring now specifically to FIGS. 2-4, in this embodiment, formation of the IPN between the infused polymeric resin 20 and native polymers 14 of the low-grade wooden body is facilitated, at least in part, via in situ synthesis of the polymeric resin 20 within the low-grade wooden body 12. The surface of native polymers 14 present in the low-grade wooden body 12 can include an abundance of hydroxyl (—OH) groups which can bind to water molecules contributing to the moisture content of the low-grade wooden body 12, as perhaps best shown in FIGS. 3 and 4. The polymeric resin 20 utilized can be one (e.g., polyurethane) having a monomeric precursor (e.g., isocyanates) that is reactive with hydroxyl groups. As will become further evident by the discussion of the method for fabricating a composite wood structure which follows with reference to FIG. 11, to invoke in situ synthesis of the polymeric resin 20, a monomeric precursor reactive with hydroxyl groups and another precursor (e.g., polyols) with which the monomeric precursor can react to form the polymeric resin 20 can be mixed. The mixture can then be introduced into the low-grade wooden body 12, where competing resin-synthesis and water-consumption reactions occur. With respect to the former, the monomeric precursor can react with either the other precursor of the polymeric resin 20 from the mixture or the hydroxyl groups on the surfaces of native polymers 14 (e.g., cellulose, hemicellulose, and/or lignin) of the low-grade wooden body 12 to form the polymeric resin 20. The synthesis of at least part of the polymeric resin 20 occurs as a result of the reaction between the monomeric precursor and the hydroxyl groups on the surfaces of native polymers 14 (e.g., the surfaces of cellulose) of the low-grade wooden bodies 12 results in a strong adherence of the polymeric resin 20 to the low-grade wooden body 12 and aids in forming the IPN therewith. With respect to the latter, the monomeric precursor can react with the hydroxyl groups of water molecules present in the low-grade wooden body 12 to form one or more other products, which, in some instances, may contribute to the material properties of the composite wood structure 10.

Referring now to FIGS. 2-6, in some embodiments, the polymeric resin 20 is polyurethane. Accordingly, in some embodiments, the polymeric resin 20 can be synthesized in situ in the low-grade wooden body 12 utilizing isocyanates as the monomeric precursor reactive with hydroxyl groups and utilizing polyols as the precursor to which the monomeric precursor can react to form the polymeric resin 20. The structure of the polymeric resin 20 synthesized can be influenced by the type of polyol utilized. In this regard, dialcohols (diols) can be utilized as polyols to facilitate the synthesis of unbranched, long-chain resin structures, while polyols including more than two hydroxyl (—OH) groups can be utilized to facilitate the synthesis of cross-linked resins. The use of a cross-linked polymeric resin in the composite wood structure 10 may be desired in some applications to further promote an inextricable formation between the polymeric resin 20 and the native polymers 14 of the low-grade wooden body 12 in establishing the IPN and for the thermoset and higher mechanical strength provided by such resins. However, both embodiments where dialcohols are utilized in combination with isocyanates as well as embodiments where polyols including more than two hydroxyl groups (e.g., triols, tetrols, pentols, hexols, etc.) are utilized in combination with isocyanates are expressly contemplated herein.

In some embodiments, the isocyanates are diisocyanates and the polyols are dialcohols. The diisocyanate and the dialcohol can be mixed and introduced into the low-grade wooden body 12. Subsequent to being introduced into the low-grade wooden body 12, some of the diisocyanate monomers react with the hydroxyl groups of the dialcohols included in the mixture and some of the diisocyanate monomers react with the hydroxyl groups provided on the surfaces of native polymers 14 in the low-grade wooden body 12 to form polyurethane and establish the IPN. Isocyanates can form strong covalent bonds with hydroxyl groups present in wood. Accordingly, in some embodiments, the reaction between the isocyanates and the hydroxyl groups on surfaces of the low-grade wooden body can result in the formation of strong, covalent bonds between the polymeric resin 20 and the native polymers 14 of the low-grade wooden body, such that first polymer network defined by the polymeric resin 20 and the second polymer network defined by the native polymers 14 forming the IPN are covalently bonded together. An example reaction scheme of a diisocyanate reacting with a dialcohol to form polyurethane is provided in FIG. 6.

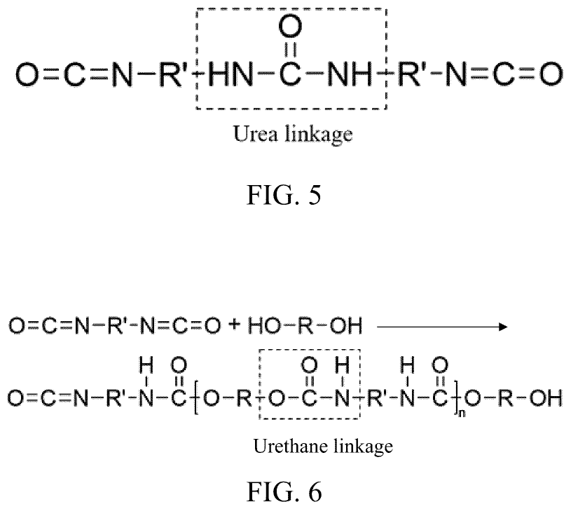

In some embodiments, other unreacted diisocyanate monomers provided in the mixture react with the hydroxyl groups of water molecules present in the low-grade wooden body 12 to produce a primary amine and carbon dioxide. The water molecules involved in such reactions are thus consumed and the moisture content of the low-grade wooden body 12 is thereby reduced. In some embodiments, the amines formed from such reaction can subsequently react with another isocyanate to form a urea, such as a diisocyanate with a urea linkage as shown in FIG. 5.

Accordingly, in some embodiments, in addition to polyurethane, the low-grade wooden body 12 is also be infused with ureas. The increased hardness of urea relative to the polyurethane can serve to improve the mechanical properties of the low-grade wooden body 12, and its thermal stability is higher than that of urethane. In some embodiments, the infusion of the low-grade wooden body 12 with a product (e.g., urea) formed by the reaction between an intermediate (e.g., an amine) and one monomeric precursor to the polymeric resin (e.g., a first diisocyanate molecule), where such intermediate is formed as a result of a reaction between another monomeric precursor to the polymeric resin (e.g., a second diisocyanate molecule) reflects the fact that the polymeric resin 20 is formed in situ within the low-grade wooden body 12.

In other embodiments, instead of dialcohols, polyols with more than two hydroxyl groups are utilized in combination with the isocyanates (e.g., diisocyanates) to facilitate in situ synthesis of a cross-linked polymeric resin within the low-grade wooden body. In situ resin synthesis utilizing polyols with more than two hydroxyl groups can be carried out in the same manner as described above using dialcohols.

In some embodiments, catalysts are utilized to increase the rate at which the polymeric resin 20 is synthesized. Catalysts which can be utilized include acidic and basic amines. In some embodiments, besides changing the rate of reaction, such catalysts can also be used to favor either urethane formation or urea formation.

Isocyanates which can be utilized as monomeric precursors to facilitate in situ synthesis of the polymeric resin 20 in various embodiments include, by non-limiting example: methylene diphenyl diisocyanate (MDI); hydrogenated methylene diphenyl diisocynate (HMDI); toluene diisocyanate (TDI); hexmethylene diisocyanate (HDI); isophorone diisocyanate (IPDI); NCO-terminated prepolymers, such as carbodiimide-modified isocyanates; and combinations thereof. Of course, the monomeric precursor is not strictly limited to isocyanates. Rather, any monomer that can react with the hydroxyl groups of water and can be polymerized within wood can be used in place of isocyanates and in conjunction with polyols which react with such monomers to form a polymer. Polyols which can be utilized as precursors to facilitate in situ synthesis of the polymeric resin 20 in various embodiments include, by non-limiting example: dipropylene glycol; 1,4-butanediol; 1,6-hexanediol; neopentyl glycol; ethylene glycol; glycerol; trimethylolpropane (TMP); pentaerythritol; and sorbitol. In some embodiments, and referring now to FIG. 1, the exterior of the low-grade wooden body 12 can optionally be incised using known techniques to facilitate penetration of the mixture of precursors for the polymeric resin 20. Accordingly, in some embodiments, the low-grade wooden body 12 can include one or more incisions 18 along its surface.

The weight percentage (wt %) of polymeric resin 20 in the composite wood structure 10 can vary depending on the type of wood utilized for the low-grade wooden body 12, the structural makeup (e.g., the number of voids) of the low-grade wooden body 12, and/or the moisture content of the low-grade wooden body 12 prior to resin infusion. In various embodiments, the composite wood structure 10 ranges from about 5 wt % to about 40 wt % polymeric resin, from about 5 wt % to about 30 wt % polymeric resin, from about 5 wt % to about 20 wt % polymeric resin, from about 5 wt % to about 15 wt % polymeric resin, or from about 5 wt % to about 10 wt % polymeric resin.

To promote curing of the polymeric resin 20 from a liquid to a solid state, the polymeric resin 20 is, in some embodiments, infused into the low-grade wooden body 12 in combination with one or more catalysts. Curing catalysts which can be utilized include, by way of non-limiting example, methyl ethyl ketone peroxide (MEKP).

In some embodiments, the synthesized polymeric resin 20 also serves to fill one or more voids 16 which are defined by, and thus can be characterized as being present within, the low-grade wooden body 12. Voids 16 present within the low-grade wooden body 12 can cause stress concentrations that can adversely affect the stiffness and load-carrying capacity of the low-grade wooden body 12. Voids 16 which can be present within the low-grade wooden body 12 can include or correspond to, by way of non-limiting example, checks, cracks, knots, wanes, piths, rot, insect-related damage, and/or voids created during the milling process. In the embodiment shown in FIGS. 1 and 2, there are two voids 16 filled by the polymeric resin 20, as perhaps shown best in FIG. 2. Of course, the number and type of voids 16 present in the low-grade wooden body 12 can vary without departing from the spirit and scope of the present disclosure. In some embodiments, where larger voids, such as checks, are present in the wooden body 12, a thixotropic liquid is additionally utilized to fill such voids.

Referring still to FIGS. 1 and 2, the interlacing between the polymeric resin 20 and the native polymers 14 of low-grade wooden body 12 in the IPN renders the interior molecular structure of the composite wood structure 10 more resistant to mechanical stress relative to that of the low-grade wooden body 12 prior to resin infusion. The filling of voids 16 present within the low-grade wooden body 12 by the polymeric resin 20 also serves to reduce stress concentrations present within the low-grade wooden body 12. As a result, the flexural strength (as measured, e.g., by a three-point bend test) of the composite wood structure 10 is generally significantly improved relative to that of the low-grade wooden body 12 prior to resin fusion.

In some embodiments, the composite wood structure 10 exhibits a multi-fold increase in flexural strength relative to the low-grade wooden body 12 prior to resin infusion. In some embodiments, the composite wood structure 10 exhibits about a 4-fold increase in flexural strength relative to that of the low-grade wooden body 12 prior to resin infusion. In some embodiments, the composite wood structure 10 exhibits about a 4.5-fold increase in flexural strength relative to that of the low-grade wooden body 12. In embodiments where the low-grade wooden body 12 is an aggregate of wooden particulate, the flexural strength of the low-grade wooden body 12 may not be measurable prior to formation of the composite wood structure. In various embodiments, the composite wood structure 10 exhibits a flexural strength ranging from about 2,200 pounds per square inch (psi) to about 8,350 psi.

In addition to facilitating the formation of the IPN, in situ synthesis of the polymeric resin 20 also provides the added benefit of reducing the moisture content (i.e., the amount of water present in) of the low-grade wooden body 12. It is appreciated that, under ideal moisture conditions (e.g., ≤about 18%), timber construction exhibits excellent durability under harsh environmental conditions. Durability can, however, be impeded if the moisture content is too low (e.g., <about 8%). Conversely, excess moisture (i.e., >about 18%) can significantly decrease the material strength and modulus. As noted above, some degree of water molecules are consumed during the in situ synthesis of the polymeric resin 20, thereby reducing the overall moisture content of the low-grade wooden body 12. The observed increases in flexural strength of certain composite wood structures made in accordance with the present disclosure further supports this contention. Accordingly, in some embodiments, the low-grade wooden body 12 infused with the polymeric resin 20, and thus the composite wood structure 10 as a whole, exhibits a lower moisture content even before any post-infusion drying treatments and/or the polymeric resin 20 is cured relative to that of the low-grade wooden body 12 immediately before being infused with the polymeric resin 20 (i.e., after any drying treatments performed prior to resin infusion).

Referring now to FIGS. 7 and 8, another composite wood structure 100 made in accordance with an embodiment of the present disclosure is provided. The composite wood structure 100 in this embodiment is of the same construction as the composite wood structure 10 described above with reference to FIGS. 1 and 2, except that the low-grade wooden body 112 infused with polymeric resin 120 is an aggregate of wood particulate instead of an incised piece of lumber. Specifically, in this embodiment, the low-grade wooden body 112 is an aggregate of sawdust.

In FIGS. 7 and 8, the wooden body 112 is generically represented by white dots while the polymeric resin 120 is generically represented by the black area around such white dots for ease in illustration. As such, it will be appreciated that the composite wood structure 110 is not limited to the specific construction shown in FIGS. 7 and 8. Accordingly, the assumed shape, distribution, amount, proportion of the aggregate of wood particulate forming the low-grade wooden body 112 and the polymeric resin 120 in the composite wood structure 100 can vary from that shown in FIGS. 7 and 8 without departing from the spirit and scope of the present disclosure. In FIG. 8, the polymeric resin 120 fills two voids 116 present in the low-grade wooden body, though the number of voids 116 present in the low-grade wooden body 112 may of course vary.

Referring still to FIGS. 7 and 8, the sawdust forming the low-grade wooden body 112 can correspond to the waste product produced during the processing of larger pieces of wood and thus may be sourced from a wide variety of wood processing operations. The sawdust forming the low-grade wooden body 112 can, in various embodiments, be derived from the processing of one or more of the hardwoods and/or one or more of the softwoods indicated above for the composite wood structure 10 described with reference to FIGS. 1 and 2. In some embodiments, the composite wood structure 100 including the low-grade wooden body 112 formed by sawdust and infused with the polymeric resin 120 exhibits a flexural strength of at least 8,000 psi. The polymeric resin 120 infused in the low-grade wooden body 112 can be the same polymeric resin 20 as used to infuse the low-grade wooden body 112 of the composite wood structure 10 described above with reference to FIGS. 1 and 2.

Referring still to FIGS. 7 and 8, in alternative embodiments, instead of sawdust, the low-grade wooden body 112 is formed of woodchips. The woodchips forming the low-grade wooden body 112 can, in various embodiments, be derived from the processing of one or more of the hardwoods and/or one or more of the softwoods indicated above for the composite wood structure 10 described with reference to FIGS. 1 and 2. In some embodiments, the composite wood structure 100 including the low-grade wooden body 112 formed by woodchips and infused with the polymeric resin 120 exhibits a flexural strength of at least about 2,200 psi.

Referring now to FIGS. 1, 2, 7, and 8, the polymeric resin 20, 120 can be infused such that each exterior surface of the low-grade wooden body 12, 112 is coated with the polymeric resin 20, 120. Accordingly, in some embodiments, in addition to minimizing the impact of stress concentrations corresponding to any voids present in the exterior surfaces of the low-grade wooden body 12, 112, the polymeric resin 20, 120 further serves to provide the composite wood structure 10, 100 with a smoother and/or more-uniform finish relative to that of the low-grade wooden body 12, 112 prior to resin infusion. Additionally, the polymeric resin 20, 120, in certain embodiments, acts as a preservative and/or repellant, thereby reducing or eliminating the need for the use of toxic coatings, such as creosote or chromated copper arsenate (CCA), which can leach out from wooden bodies and pollute the surrounding environment.

The present disclosure is further based, in part, on the discovery that wrapping low-grade wooden bodies infused with polymeric resin in fiber-reinforced polymers (FRPs) can reinforce and significantly improve the mechanical strength of such infused wooden bodies. Accordingly, in some embodiments, the present disclosure further includes composite wood structures which make use of an FRP.

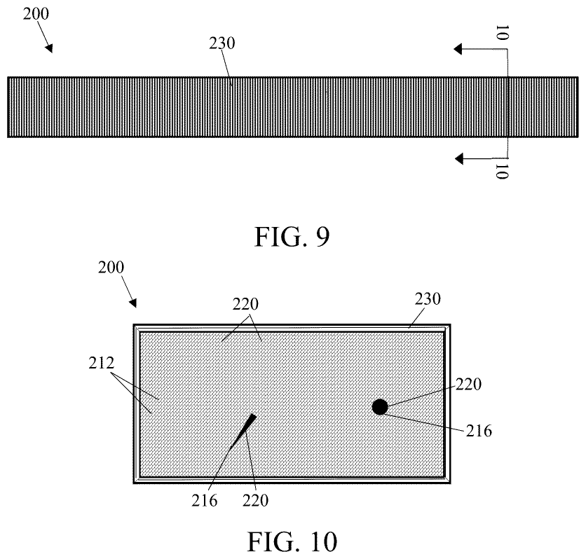

Referring now to FIGS. 9 and 10, another composite wood structure 200 made in accordance with an embodiment of the present disclosure is provided. The composite wood structure 200 in this embodiment is of the same general construction as the composite wood structure 100 described above with reference to FIGS. 7 and 8, except that the composite wood structure 200 further includes a FRP 230. Accordingly, like the composite wood structure 100 described above with reference to FIGS. 7 and 8, the composite wood structure 200 in this embodiment also includes a low-grade wooden body 212 that is formed by an aggregate of wood particulate and infused with a polymeric resin 220. However, instead of sawdust, the wood particulate forming the low-grade wooden particulate is woodchips. The woodchips forming the low-grade wooden body 212 can, in various embodiments, be derived from the processing of one or more of the hardwoods and/or one or more of the softwoods described with reference to FIGS. 1 and 2. The polymeric resin 220 infused in the low-grade wooden body 212 can be the same polymeric resin 20 as used to infuse the low-grade wooden body 212 described above with reference to FIGS. 1 and 2.

In FIGS. 9 and 10, the wooden body 212 is generically represented by white blocks while the polymeric resin 220 is generically represented by the black lines between such white blocks for ease in illustration. As such, it will be appreciated that the composite wood structure 210 is not limited to the specific construction shown in FIGS. 9 and 10. Accordingly, the assumed shape, distribution, amount, proportion of the aggregate of wood particulate forming the low-grade wooden body 212 and the polymeric resin 220 in the composite wood structure 200 can vary from that shown in FIGS. 9 and 10 without departing form the spirit and scope of the present disclosure. In FIG. 10, the polymeric resin 220 fills two voids 216 present in the low-grade wooden body, though the number of voids 216 present in the low-grade wooden body 212 may of course vary.

It will be appreciated that while the native polymers of the low-grade wooden body 112, 212 are not depicted in FIGS. 7-10 that the polymeric resin 120, 220 in such embodiments can similarly interact with the native polymers present in such low-grade wooden bodies 112, 212 in the manner described above to form an IPN.

Referring now again to FIGS. 9 and 10, the FRP 230 includes fibers embedded in a polymer resin. In various embodiments, fibers of the FRP 230 can be in the form of a woven fabric, a non-woven veil, a stitched fiber assembly, a fiber mat, and combinations thereof. In some embodiments, the fibers utilized in the FRP 230 have a tensile strength ranging from about 1.5 gigapascal (GPa) to about 6.0 GPa. Fibers that can be utilized in the construction of the FRP 230 include, by non-limiting example, E-glass fibers, aramid fibers (e.g., KEVLAR®), carbon fibers, Kenaf fibers, and combinations thereof. Fiber form and type can be selected based on the degree of conformity needed with the surface of the low-grade wooden body 212, resin flow capabilities, and/or strength requirements. Hybrid fibers (including discarded fibers from furnace filters) including a combination of different fibers can be developed to accommodate specific stiffness, ductility, and/or energy absorption requirements. Resins that can be utilized to embed such fibers include, by non-limiting example, polyurethane resins, epoxy resins, vinyl ester resins, and phenolic resins.

Referring still to FIGS. 9 and 10, in this embodiment, the FRP 230 is wrapped around the low-grade wooden body 212 infused with polymeric resin 220, such that the FRP 230 fully covers the top surface, the bottom surface, the side surfaces, and the end surfaces of the infused low-grade wooden body 212. In this regard, the FRP 230 of the composite wood structure 200 shown in FIGS. 9 and 10 can be characterized as encapsulating the infused low-grade wooden body 212. However, embodiments in which the FRP 230 is provided on the infused low-grade wooden body 212 as to only fully cover a subset of its exterior surfaces of the infused low-grade wooden body 212, as well as embodiments in which the FRP 230 is provided on the infused low-grade wooden body 212 as to only partially cover one or more of the exterior surfaces of the infused low-grade wooden body 212, are also contemplated herein. For instance, in some embodiments, the FRP 230 comprises two separate FRP members, with a first FRP member applied to a first face of the resin-infused low-grade wooden body 212 and a second FRP member applied to a second face of the resin-infused low-grade wooden body that is opposite of the first face of the low-grade wooden body.

Referring still to FIGS. 9 and 10, in this embodiment, the FRP 230 is provided such that the fibers of the FRP 230 are oriented at a 90° angle relative to a longitudinal axis of the infused low-grade wooden body 212. The FRP 230 can, however, be differently positioned to adjust the orientation of the fibers of the FRP 230 relative to the infused low-grade wooden body in order to accommodate different structural demands. For instance, in some embodiments, instead of a 90° angle, the fibers of the FRP 230 are oriented at a 0° angle, a ±45° angle, or multiple different angles relative to the longitudinal axis of the low-grade wooden body. In some embodiments, the composite wood structure 200 including the infused low-grade wooden body 212 formed by woodchips and the FRP 230 exhibit a flexural strength in the order of 9,000 psi. Of course, the flexural strength will typically vary, and thus can be higher, depending on the density and orientation of the FRP 230. In this regard, it will be appreciated that different orientations of fibers and their density affect different thermos-mechanical properties, such as thermal conductivity, bending, sheer stress, etc. As such, the fibers can be oriented to tailor such for a particular application.

Referring still to FIGS. 9 and 10, in alternative embodiments, instead of woodchips, the low-grade wooden body 212 is formed of sawdust. The sawdust forming the low-grade wooden body 212 can, in various embodiments, be derived from the processing of one or more of the hardwoods and/or one or more of the softwoods indicated above for the composite wood structure 10 described with reference to FIGS. 1 and 2. In some embodiments, the composite wood structure 200 including the infused low-grade wooden body 212 formed by sawdust and the FRP 230 exhibits a flexural strength of at least 16,000 psi. In some embodiments, a composite wood structure constructed in the manner disclosed herein and including a FRP exhibits a flexural strength ranging from about 9,000 psi to about 16,000 psi. In still other alternative embodiments, the infused low-grade wooden body 212 is a piece of lumber selected from one of the hardwoods or softwoods indicated above for the composite wood structure 10 described above with reference to FIGS. 1 and 2. That is, composite wood structure embodiments including a piece of lumber infused with a polymeric resin and partially or fully wrapped in a FRP 230 are also contemplated herein.

Referring still to FIGS. 9 and 10, as noted, in some embodiments, the FRP 230 can encapsulate the resin-infused low-grade wooden body 212. Accordingly, in some embodiments, in addition to improving the strength characteristics of the composite wood structure 200, the FRP 230 further serves to provide the composite wood structure 200 with a smoother and/or more-uniform finish relative to that of the low-grade wooden body 212, either prior or subsequent to resin infusion. Additionally, the polymeric resin 220 and/or FRP 230 can act as a preservative and/or repellant and thereby reduce or eliminate the need for the use of toxic coatings, such as creosote or chromated copper arsenate (CCA), which can leach out from wooden bodies and pollute the surrounding environment.

In some embodiments, the composite wood structures 10, 100, 200 described above with reference to FIGS. 1, 2, and 7-10, possess structural and/or appearance characteristics that qualify the composite wood structures 10, 100, 200 for a particular commercial-grade rating. For instance, in some embodiments, the composite wood structures 10, 100, 200 possess characteristics which qualify the composite wood structures 10, 100, 200 to receive a commercial-grade rating of No. 2 or higher or a commercial-grade rating of No. 2B or higher. A composite wood structure qualifying for a particular commercial-grade rating can be considered as having the particular commercial-grade rating, even if such rating is not formally assigned.

Although the disclosed composite wood structures 10, 100, 200 are primarily described above in the context of including a low-grade wooden body, composite wood structures made in accordance with the present disclosure are not necessarily limited to those which include a low-grade wooden body. Rather, composite wood structures which are formed, at least in part, by a high-grade wooden body infused with polymeric resin are also expressly contemplated herein. For instance, in alternative embodiments, instead of a low-grade wooden body, the composite wood structures 10, 100, 200 described include a resin-infused wooden body in the form of a hardwood or softwood piece of lumber having a commercial-grade rating of No. 2B or No. 2, respectively, or higher, where the composite wood structure exhibits improved mechanical properties (e.g., flexural strength) relative to the hardwood or softwood piece of lumber prior to resin infusion. In situ resin synthesis, moisture reduction, void filling, and IPN formation is achieved utilizing high-grade wooden bodies in the same manner as described above utilizing low-grade wooden bodies. As such, the mechanical properties of a high-grade wooden body can also be upgraded through polymeric resin fusion. High-grade wooden bodies can be of the same types and species of wood material as described above for the low-grade wooden bodies.

The various embodiments of the disclosed composite wood structures can be produced through various implementations of a method for fabricating a composite wood structure disclosed herein.

The various wooden bodies described above for the composite wood structures 10, 100, 200, described above with reference to FIGS. 1, 2 and 7-10 can be utilized in various implementations of the method for fabricating a composite wood structure disclosed below. Accordingly, in some implementations, the wooden body utilized in the disclosed methods is a low-grade wooden body consistent with that disclosed above, while, in other implementations the wooden body is a high-grade wooden body.

Referring now to FIG. 11, in one exemplary implementation of a method for fabricating a composite wood structure, a wooden body is first partially dried, as indicated by step 302. As noted above, and as will become further evident in the discussion that follows, the infusion of the wooden body with polymeric resin via in situ resin synthesis in subsequent methods steps serves to reduce the moisture content of the wooden body, thus alleviating the need to dry the wooden body to an ideal moisture content between about 8% and about 18%. As such, the extent to which the wooden body is dried in step 302 is significantly reduced relative to that employed in other wood impregnation or infusion methods known in the art. Without wishing to be bound by theory, it is believed the reduction in moisture content facilitated by in situ resin synthesis can significantly reduce manufacturing energy as compared to wood processing involving traditional drying techniques.

In some implementations, during step 302, the wooden body is partially dried such that the moisture content of the wooden body is greater than 18% following drying. For instance, in some implementations, the wooden body is partially dried during step 302 so that its moisture content is between 18.1% and 30% after drying.

Partial drying of the wooden body during step 302 can be performed utilizing techniques and equipment for lumber drying known in the art. In this regard, in some implementations, the wooden body is partially dried by depositing the wooden body into a kiln at a predetermined temperature for a predetermined period of time. For instance, in one such implementation, the wooden body is partially dried to a predetermined moisture content by depositing the wooden body into a kiln heated to 105° C. for a period of 24 hours. Of course, the temperature and/or duration of deposit can be adjusted based on the initial moisture content of the wooden body (i.e., the moisture content of the wooden body prior to drying) and the moisture content the wooden body is desired to possess post-drying.

It is appreciated that while the methods described herein are primarily described as including a partial drying step 302, in some instances, the moisture content of the wooden body utilized may already have a moisture content within a desired range (e.g., between 18.1% and 30%) or at a particular desired percentage, such that the partial drying step 302 can be omitted altogether. Accordingly, in some implementations, a method for fabricating a composite wood structure commences with step 304 described below.

Once the wooden body is partially dried or otherwise possesses the desired moisture content, the wooden body is infused with a polymeric resin, as indicated in step 304 of FIG. 11. As discussed above, it has been surprisingly discovered that both the formation of an IPN between a polymeric resin and the native polymers of the wooden body and the reduction of moisture content in the wooden body are provided by polymeric resin infusion facilitated via in situ resin synthesis within the wooden body. Infusing the wooden body with polymeric resin in step 304 can thus involve synthesizing polymeric resin in situ within the wooden body, which attains increased strength and stiffness after synthesis. In situ synthesis of the polymeric resin can be accomplished, in some implementations, in the same manner as described above in the discussion of the composite wood structure 10 with reference to FIGS. 1-6.

In some implementations, polyurethane is synthesized within the wooden body during step 304. Accordingly, in some implementations, isocyanate monomers, such as diisocyanates, and polyols are utilized as precursors to promote the subsequent synthesis of polyurethane. In determining the ratio of isocyanate to polyol needed to achieve the desired resin synthesis, the moisture content of the wooden body subsequent to being partially dried is preferably taken into account to address the reactions anticipated to occur between the isocyanate monomers and the hydroxyl groups of the water molecules present in the wooden body. The determined precursor ratio taking into account the moisture content can then subsequently be adjusted to account for the hydroxyl groups present on surfaces of the native polymers (e.g., cellulose, hemicellulose, and lignin) of the wooden body. Increasing the amount of isocyanate monomers by about 20% relative to the amount determined taking the moisture content into account has been found to help promote full reaction with all available hydroxyl groups. In some implementations, the polyol within the isocyanate to polyol ratio is purposefully reduced to promote increased moisture reduction within the wooden body.

Subsequent to determining the ratio of isocyanates to polyols needed to facilitate the desired resin synthesis, the isocyanate monomers and polyols are mixed, preferably at room temperature. At room temperature, the reaction between isocyanate monomers and polyols can proceed slowly, leaving a large portion of the isocyanate monomers and polyols unreacted. The mixture of isocyanates and polyol precursors is then introduced, preferably immediately post-mixing, into the wooden body. To promote penetration of the mixture into the wooden body, the mixture is, in some implementations, introduced into the wooden body under pressure at room temperature. In some implementations, the mixture is introduced under vacuum pressure (i.e., <1 atmosphere (atm)). In other implementations, the mixture is introduced above atmospheric pressure (i.e., >1 atm), which, without wishing to be bound by theory, serves to improve the bonding of the polymeric resin with the wooden body and reduces the void content therein, thereby further improving the strength of the wooden body. In some implementations, to further promote penetration of the mixture into the wooden body, one or more exterior surfaces of the wooden body can optionally be incised to include one or more incisions prior to application of the mixture to the wooden body.

The mixture of isocyanate monomers and polyols can be applied under pressure using known resin impregnation techniques and equipment, including, by way of non-limiting example, vacuum-assisted resin transfer molding (VATM) and compression molding techniques and machinery. For instance, in some implementations, where the wooden body, is a piece of lumber, VATM can be employed to apply the mixture to the wooden body under pressure. In other implementations, where the wooden body is an aggregate of wood particulate, compression molding can be employed to apply the mixture to the wooden body under pressure. In implementations where the wooden body is an aggregate of wood particulate, it is appreciated that the wood particulate making up the aggregate will typically be placed in a mold to form the aggregate prior to applying the mixture to the aggregate of wood particulate. The duration and pressure under which the mixture is applied to the wooden body can be adjusted to accommodate the viscosity characteristics of the mixture and/or the structural composition of the particular wooden body being utilized. For instance, in some implementations, the mixture of isocyanate monomers and polyols is applied to the wooden body under a pressure that is below 50 atm. In some implementations, the mixture of isocyanate monomers and polyols is applied to the wooden body under a pressure ranging from about 1 atm to about 14 atm for a duration ranging between 1 minute to 12 hours. In some implementations, the mixture of isocyanate monomers and polyols is applied to the wooden body under a pressure ranging between 1 atm to 10 atm and a duration ranging between one to 10 minutes. Wood pores can, in some instances, collapse at elevated pressures between around 70 atm and 100 atm. As such, in some implementations, introduction of the mixture to the wooden body occurs at pressures below this range.

As discussed above, isocyanate monomers introduced into the wooden body react with the hydroxyl groups of the polyols of the mixture and the hydroxyl groups provided on surfaces of native polymers of the wooden body to form polyurethane and establish the IPN. As further discussed above, the isocyanate monomers introduced into the wooden body also react with the hydroxyl groups of water molecules present in the wooden body to reduce the moisture content of the wooden body and produce primary amines and carbon dioxide, where the primary amines can subsequently react with an isocyanate (e.g., diisocyanate) to form a urea. Thus, by synthesizing polyurethane in situ in the foregoing manner, the moisture content of the wooden body is effectively reduced. In some implementations, the in situ synthesis of the polymeric resin results in the moisture content of the wooden body being reduced to 18% or lower. In some implementations, the in situ synthesis of the polymeric resin results in the moisture content of the wooden body being reduced to between 8% and 18%.

To accelerate each of the above-noted isocyanate reactions and polyurethane synthesis, in some implementations, following application of the mixture of isocyanate monomers and polyols to the wooden body under pressure, the wooden body is subjected to a heated environment (i.e., an environment having a temperature above room temperature). For instance, in some implementations, the wooden body with the mixture of isocyanate monomers and polyols applied thereto is placed in an environment with a temperature ranging from 60° C. to 80° C. for a period of time ranging from 5 minutes to 10 minutes. Additionally or alternatively, catalysts can be provided with the mixture to accelerate the reaction of the isocyanate monomers. For instance, in some implementations, acidic or basic amines are utilized to accelerate some or all of the foregoing reactions. Of course, in instances where both a reaction catalyst and heating is utilized, the duration to which the wooden body is heated following application of the mixture can increase or decrease depending on the amount of catalyst utilized.

In some implementations, polyurethane is synthesized in situ in the manner described above utilizing toluene diisocyanate (TDI) and dipropylene glycol. Of course, other isocyanate monomers and/or polyols can also be utilized. For instance, in some implementations, instead of TDI, the isocyanate monomers is selected from: hydrogenated methylene diphenyl diisocynate (HMDI); toluene diisocyanate (TDI); hexmethylene diisocyanate (HDI); isophorone diisocyanate (IPDI); and NCO-terminated prepolymers, such as carbodiimide-modified isocyanates. In some implementations, instead of dipropylene glycol, the polyol is selected from: 1,4-butanediol; 1,6-hexanediol; neopentyl glycol; ethylene glycol; glycerol; trimethylolpropane (TMP); pentaerythritol; and sorbitol. The isocyanate monomers and polyols utilized for polyurethane synthesis can be selected based on the properties the polyurethane is desired to exhibit.

Although in situ resin synthesis is primarily described above in the context of synthesizing polyurethane, it is appreciated that other polymeric resins can be similarly synthesized in situ within the wooden body employing the same techniques as those described above with reference to step 304 in FIG. 11. In some embodiments, any monomer that can react with the hydroxyl groups of water on surfaces of the wood body and can be polymerized within the wood body can be used in place of isocyanates and in conjunction with polyols. In this regard, diacids can react with polyols in the same way as diisocyanates react with polyols. Indeed, unsaturated polyesters can be made by reacting maleic acid (a diacid) with ethylene glycol. The use of maleic anhydride may, however, be preferred rather than maleic acid to reduce the formation of water. Thus, if maleic anhydride is utilized in place of diisocyanate with polyols, a polyester can be synthesized instead of polyurethane. Acid groups of the maleic anhydride can react with the hydroxyl groups on the surfaces of the native polymers of the wooden body to link the polyester to the native polymers of the wooden body in similar fashion as noted above with regards to in situ resin synthesis. Accordingly, in some implementations, instead of polyurethane, polyester resin is synthesized in situ utilizing maleic anhydride monomers and glycerol.

Following synthesis of the polymeric resin, the resin-infused wooden body is cured, as indicated by step 306 in FIG. 11, such that the polymeric resin transitions from a liquid to a solid state. In some implementations, the polymeric resin infused within the wooden body is cured by placing the resin-infused wooden body under pressure at a predetermined temperature for a predetermined duration. For instance, in some implementations, the resin-infused wooden body is subjected to pressures ranging from 1 atm to 10 atm at a temperature ranging from 60° C. to 80° C. for a period ranging from one minute to 10 minutes. Additionally or alternatively, to accelerate the curing of the resin-infused wooden body, a curing catalyst, such as methyl ethyl ketone peroxide (MEKP), can be provided with the mixture of polymeric resin precursors applied to the wooden body.

In some implementations, once the resin-infused wooden body is cured, the method for fabricating a composite wood structure concludes. Accordingly, in some implementations, the method for fabricating a composite wood structure produces a composite wood structure like that of the composite wood structures 10, 100 described above with reference to FIGS. 1, 2, 7, and 8.

In other implementations, however, the method for fabricating a composite wood structure further includes an additional step of applying a fiber-reinforced polymer (FRP) to the cured resin-infused wooden body to further improve the strength characteristics of the composite wood structure, as indicated by step 308 in FIG. 11. Accordingly, in some implementations, the method for fabricating a composite wood structure produces a composite wood structure like that of the composite wood structure 200 described above with reference to FIGS. 9 and 10.

The same FRPs as described above for the composite wood structure 200 described above with reference to FIGS. 9 and 10 can be utilized in various implementations of step 308. Such FRPs can be applied to and oriented about the resin-infused wooden body in the same fashion as described above for the composite wood structure 200 described above with reference to FIGS. 9 and 10 in various implementations of step 308.

To help ensure the FRP remains in association with the resin-infused wooden body, in some implementations, the FRP is fabricated on the cured resin-infused wooden body. In this regard, the fibers of the FRP can first be applied to a single or multiple exterior surfaces of the cured resin-infused wooden body prior to being embedded in resin. In instances where the FRP is intended to partially or fully cover multiple surfaces of the cured resin-infused wooden body, applying the fibers to the cured resin-infused wooden body can involve wrapping or folding the fibers of the FRP about the cured resin-infused wooden body. In some implementations, applying the fibers of the FRP to the cured resin-infused wooden body can involve encapsulating the cured resin-infused wooden body with the fibers of the FRP.

Once the fibers of the FRP are applied (which may include applying a fabric including multiple fibers) to the cured resin-infused wooden body in the desired manner, the resin to the FRP is applied to bond the fibers and the wooden body together, and subsequently cured, thereby forming the FRP and adhering the FRP to the cured resin-infused wooden body. In some implementations, the resin to the FRP is vinyl ester resin. In some implementations, vacuum-assisted resin transfer molding (VARTM) is utilized in the formation of the FRP and its adherence to the cured resin-infused wooden body, while, in other implementations, compression molding methods are used. Depending on the intended application of the composite wood structure, VARTM or compression molding can be selected. Without wishing to be bound by any particular theory, it is believed that, in instances where the wooden body corresponds to an aggregate of wood particulate, such as woodchips, compressing the resin-infused wooden substrate while the FRP is applied using compression molding techniques imbues the resulting composite wood structure with higher stress to failure tolerance.

To facilitate curing of the resin of the FRP heat and/or pressure is, in some implementations, applied for a predetermined period of time. For instance, in some implementations, the resin of the FRP is cured by subjecting the assembly including the fibers of the FRP, the resin of the FRP, and the cured resin-infused wooden body to pressures ranging from 1 atm to 10 atm at a temperature ranging from 60° C. to 80° C. for a period ranging from one minute to 10 minutes. In alternative implementations, the fibers and resin of the FRP are applied at ambient air pressure to the resin-infused wooden body and cured at temperatures ranging from 10° C. to 25° C. In such implementations, a plastic sheathing, such as shrink wrap, can be applied over the FRP to promote adherence of the FRP to the resin-infused wooden body. Additionally or alternatively, to accelerate the curing of the resin of the FRP, a curing catalyst, such as methyl ethyl ketone peroxide (MEKP), can be provided with the is first fabricated and then applied to the desired surfaces of the cured resin-infused wooden body via adhesives or other suitable securing means. FRPs can be fabricated utilizing known FRP manufacturing techniques and equipment. For instance, in some implementations, the FRP utilized in step 308 is manufactured via hand lay-up, spray-up, resin transfer molding (RTM), pultrusion, VARTM, or compression molding.

The presently disclosed subject matter is further illustrated by the following specific but non-limiting examples. The following examples may include compilations of data that are representative of data gathered at various times during the course of development and experimentation related to the present disclosure.

### EXAMPLES

### Example 1: Upgrading Low-Grade Wood Via Resin Infusion

In an initial study, it was assessed whether the mechanical properties of lumber that would normally be discarded as waste or used as fuel could be improved to that closer of wood with higher commercial-grade ratings. In this regard, a low-grade wood sample in the form of a piece of southern yellow pine (SYP) lumber, with a commercial-grade rating of No. 4 (discarded wood), was infused with a polyurethane resin to produce a composite wood structure (FIG. 12B). An incised piece of SYP lumber with a commercial-grade rating of No. 4 (discarded wood) was also infused with polyurethane resin in the same manner to produce another composite wood structure (FIG. 13B). The mechanical properties of these composite wood structures were compared against a similarly grade rated untreated SYP lumber sample (FIG. 12A) and against an untreated high-grade wood sample in the form of a piece of red oak lumber.

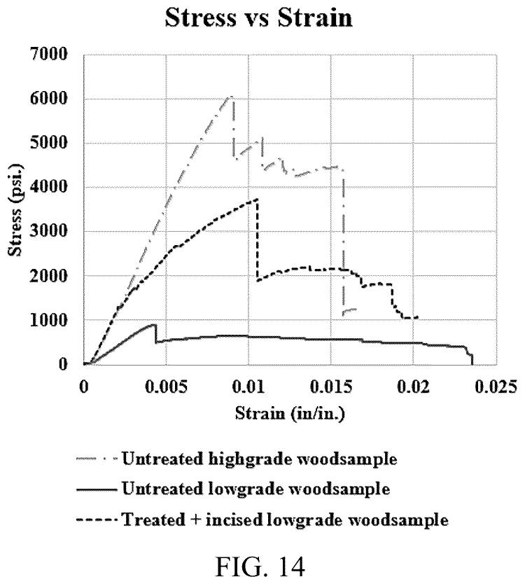

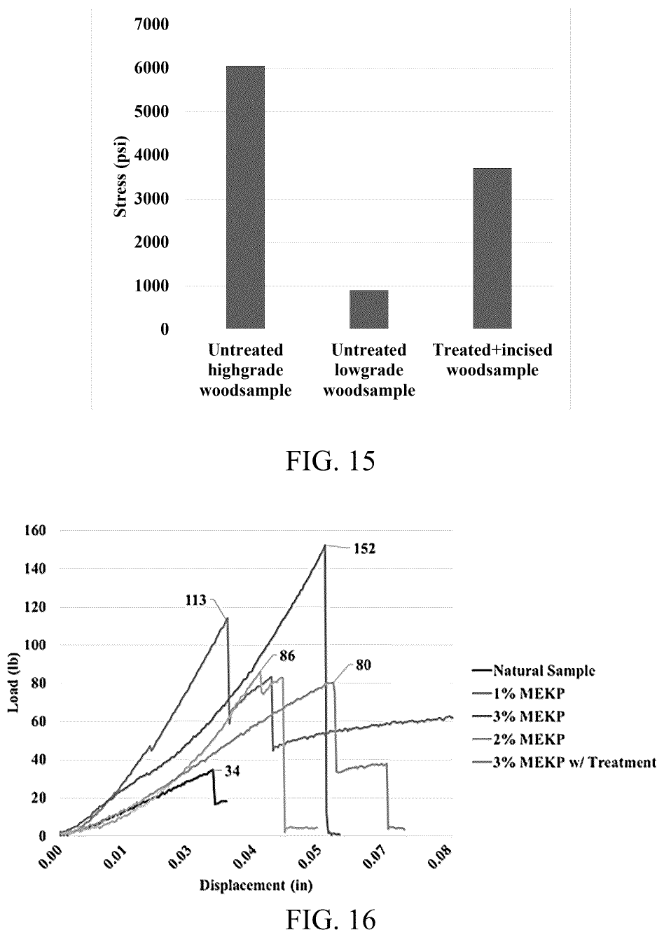

The composite wood structure shown in FIG. 12B was prepared by first drying the SYP wood sample at 105° C. for a period of 24 hours to reduce the moisture content of the wood sample. After drying, the wood sample was pressurized with polyurethane resin at 50 psi for a period of 3 hours at room temperature via compression molding. The polyurethane was synthesized in situ within the SYP wood sample by mixing toluene diisocyanate and dipropylene glycol, and applying the mixture to the SYP wood sample under the above-noted conditions. Curing of the resin-infused wood sample was performed under pressure at 50 psi for 48 hours at 75° C. The incised, composite wood structure comprising the incised piece of SYP lumber shown in FIG. 13B was prepared in the same fashion as the composite wood structure shown in FIG. 12B, except for incising. Once cured, the stress versus strain (FIG. 14) and the flexural strength (three-point bend test) (FIG. 15) characteristics of the two resin-infused wood samples were compared against the untreated SYP wood sample (FIG. 12A) and against the untreated red oak wood sample.

As shown in FIG. 14, the stiffness, ultimate tensile strength, and toughness of the treated and incised SYP sample were each significantly increased relative to that of the untreated SYP sample, thus indicating considerable structural strength improvement in the treated SYP sample. It is likely that energy absorption (toughness) improvements of the treated wood sample may not be dramatically different from the untreated high-grade wood sample.

As shown in FIG. 15, the flexural strength was found to be: 958 psi for the untreated SYP sample; 3,812 psi for the treated and incised SYP sample; and around 6,000 psi for the untreated high-grade red oak sample. The non-incised resin-infused SYP sample was found to exhibit a flexural strength of 4,282 psi. Accordingly, incised resin-infused SYP wood sample was found to exhibit about a 400% strength increase over the untreated low-grade SYP wood sample, and the non-incised resin-infused SYP wood sample was found to exhibit about a 450% strength increase over the untreated low-grade SYP wood sample.

### Example 2: Effect of Curing Catalyst

To assess the effect of different curing catalyst concentrations on the structural characteristics of untreated low-grade wood samples and low-grade wood samples treated with resin infusion, the load versus displacement of five different wood samples was assessed. All samples tested were discarded wood (i.e., commercial-grade rating No. 4 or below based on visual grading). Three samples were prepared by subjecting non-incised low-grade SYP lumber to a resin-infusion treatment consistent with that described above for the treated SYP samples in Example 1, except that each sample received a different concentration (1% to 3%) of the curing catalyst methyl ethyl ketone peroxide (MEKP) during resin infusion, identified in FIG. 16 as “1% MEKP”, “2% MEKP”, and “3% MEKP”. One sample was prepared by subjecting a low-grade SYP piece of lumber to a resin-infusion treatment consistent with that described above for the treated SYP samples in Example 1, except that the sample received 3% MEKP during resin infusion and was treated with benzyl alcohol at 50 psi for 5 hours, identified in FIG. 16 as “3% MEKP w/ Treatment.” The load versus displacement characteristics of the four samples were compared against each other, as well as against an untreated (natural) low-grade SYP lumber sample.

As shown in FIG. 16, the 3% MEKP sample provided the maximum increase in failure load component to any other treatments or lower percentages of MEKP. Even though slight stiffness deration is noted with 3% MEKP, the overall performance, including energy absorption, was superior to other treatments.

### Example 3: Composite Wood Structures from Woodchip Particulate

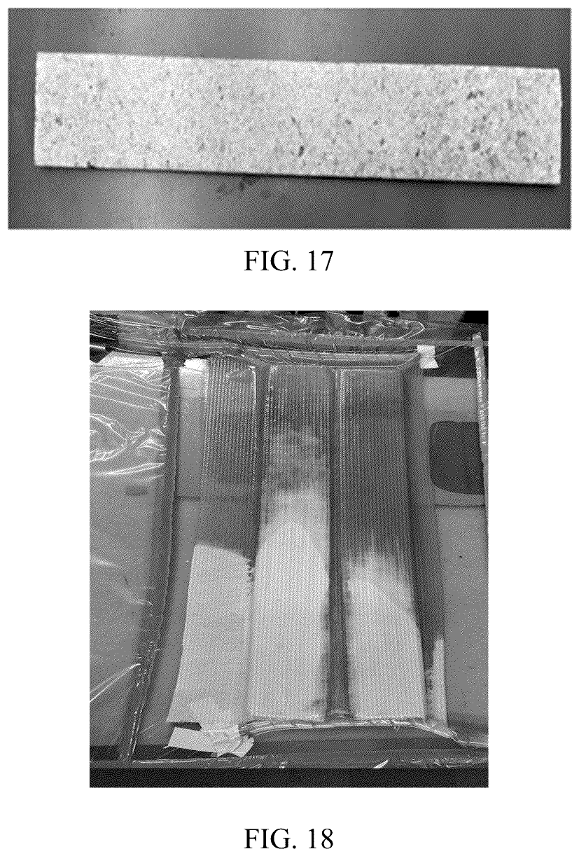

To assess the extent to which woodchips can be utilized in composite building materials and the extent to which the mechanical properties of such composites can be upgraded by the application of fiber-reinforced polymers (FRPs), two composite wood structures comprising an aggregate of woodchips were prepared and tested. In this regard, a first, non-FRP wrapped (or “unwrapped”) composite wood structure (FIG. 17) comprising an aggregate of woodchips infused with a polyurethane resin was prepared by mixing woodchips with mixed precursors of polyurethane (toluene diisocyanate and dipropylene glycol) and compression molding. In this regard, woodchips were placed into a mold pre-treated with a release agent. The precursors of the polyurethane were mixed and added inside the mold. Pressure was then applied up to 200 psi for approximately 12 hours. The mold was then heated to 80° C. and maintained at that temperature until the resin was fully cured.

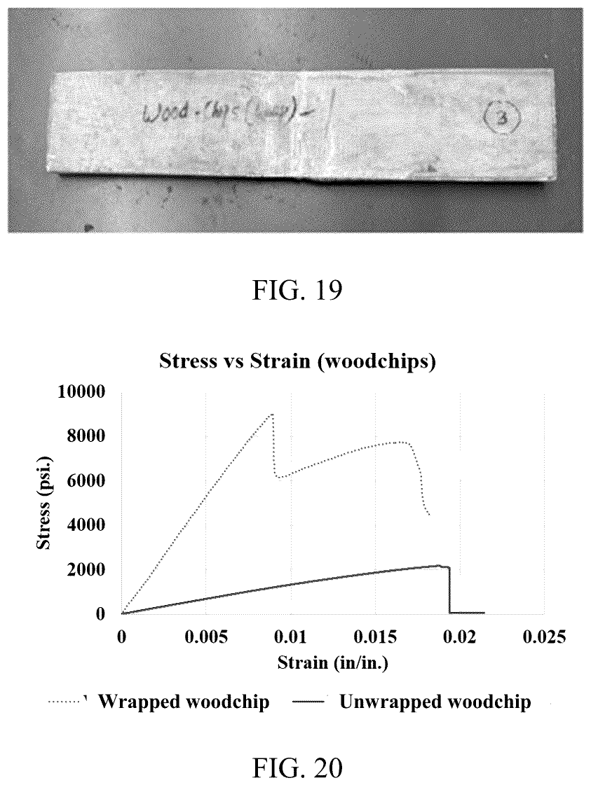

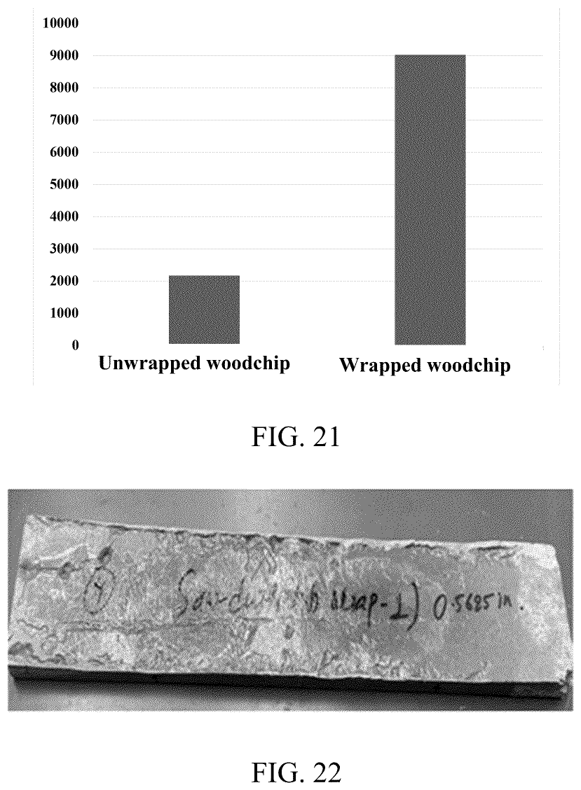

A second, FRP-wrapped (or “wrapped”) composite wood structure (FIGS. 18 and 19) comprising an aggregate of woodchips infused with a polyurethane resin and wrapped with an E-glass FRP was prepared by mixing woodchips with mixed precursors of polyurethane and compression molding to form a resin-infused wooden body in the same fashion as noted above. The resin-infused wooden body was then wrapped with glass fabric and brushed with vinyl ester coating before being subjected to compression molding for several hours at 50° C. Once prepared, the stress versus strain (FIG. 20) and flexural strength (three-point bend test) (FIG. 21) of the two composite wood structures were compared.

As shown in FIG. 20, the stiffness, ultimate tensile strength, and toughness of the wrapped composite wood structure were each significantly increased relative to that of the unwrapped composite wood structure, while the ductility of the wrapped composite wood structure was reduced (but overall toughness increased) relative to the unwrapped composite wood structure, thus indicating that the FRP wrap provided considerable structural benefit.

As shown in FIG. 21, the flexural strength of the unwrapped composite wood structure was found to be about 2,200 psi, whereas the wrapped composite wood structure was found to be about 9,000 psi. Accordingly, the wrapped composite wood structure provided about a 400% increase in flexural strength over the unwrapped composite wood structure. Therefore, for a small increase in cost for wrapping, four-fold strength and stiffness increases, as well as aesthetic considerations including color could be attained via wrapping of resin-infused woodchip samples with an FRP.

### Example 4: Composite Wood Structures from Sawdust Particulate

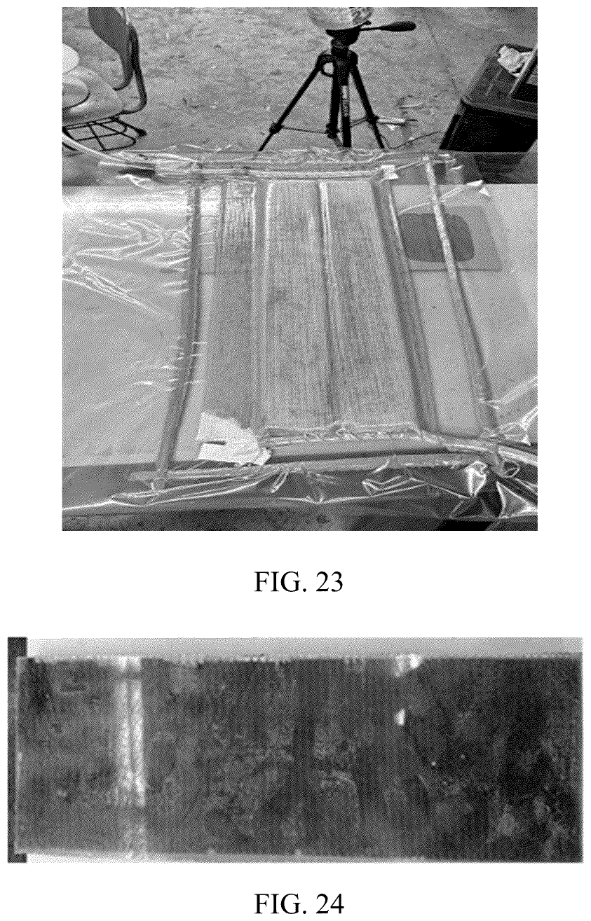

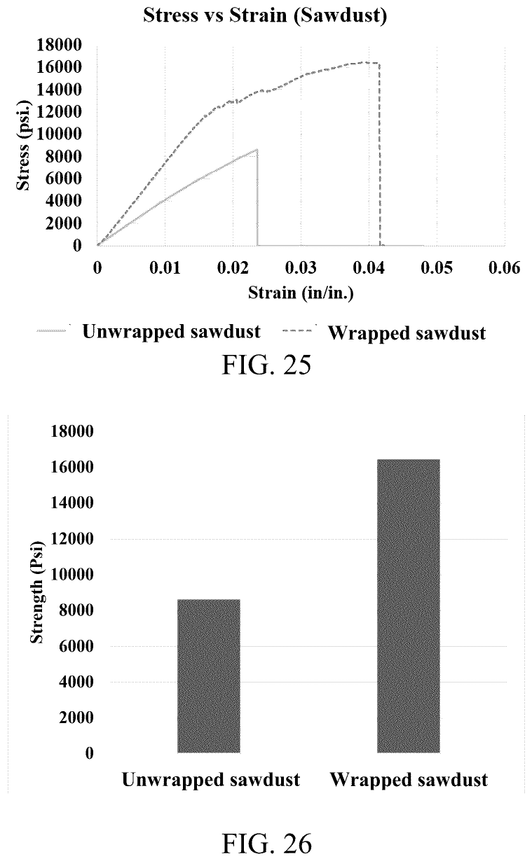

To assess the extent to which sawdust can be utilized in composite building materials and the extent to which the mechanical properties of such composites can be upgraded by the application of fiber-reinforced polymers (FRPs), two composite wood structures comprising an aggregate of sawdust were prepared and tested. A first, non-FRP wrapped (or “unwrapped”) composite wood structure (FIG. 22) comprising an aggregate of sawdust infused with a polyurethane resin was prepared in the same general manner as the unwrapped woodchip sample shown in FIG. 17 and discussed above in Example 3. A second, FRP-wrapped (or “wrapped”) composite wood structure (FIGS. 23 and 24) comprising an aggregate of sawdust infused with a polyurethane resin and wrapped with an E-glass FRP was prepared in the same general manner as the unwrapped woodchip sample shown in FIG. 17 and discussed above in Example 3. Once prepared, the stress versus strain (FIG. 25) and flexural strength (three-point bend test) (FIG. 26) of the two composite wood structures were compared.

As shown in FIG. 25, the stiffness, ultimate tensile strength, ductility, and toughness of the wrapped composite wood structure were each significantly increased relative to that of the unwrapped composite wood structure, thus indicating that the FRP wrap provided considerable structural benefit. Even though the experimental data revealed an approximately 50% increase in potential load design, without wishing to be bound by theory, it was believed that additional FRP wrapping can increase the design stress by a factor ranging from 2 to 3.

As shown in FIG. 26, the flexural strength of the unwrapped composite wood structure in this Example 4 was found to be about 8,300 psi, whereas the wrapped composite wood structure was found to be about 16,000 psi. Accordingly, the wrapped composite wood structure in this example provided about a 190% increase in flexural strength over the unwrapped composite wood structure.

The results of this study (as well as that in Example 3) indicate that the wrapping of resin-infused wooden bodies corresponding to aggregates of wood particulate may be preferred as it provides better warring under failure loads than unwrapped structures.

### REFERENCES

All publications, patents, and patent applications mentioned in this specification are herein incorporated by reference to the same extent as if each individual publication, patent, or patent application was specifically and individually indicated to be incorporated by reference, including the references set forth in the following list:
1. A. K. Bledzki, S. Reihmane, and J. Gassan “Thermoplastics Reinforced with Wood Fillers: A literature Review”, Polym.-Plast. Technol. Eng., 37(4), pp 451-468, 1998.

It will be understood that various details of the presently disclosed subject matter can be changed without departing from the scope of the subject matter disclosed herein. Furthermore, the foregoing description is for the purpose of illustration only, and not for the purpose of limitation.

What is claimed is:

1. A composite wood structure, comprising a wooden body infused with a polymeric resin, the polymeric resin forming a heterogeneous interpenetrating polymer network (IPN) with native polymers of the wooden body.

2. The composite wood structure of claim 1, wherein the IPN comprises a first polymer network defined by the native polymers of the wooden body and a second polymer network defined by the polymeric resin, wherein the first polymer network is covalently bonded to the second polymer network.

3. The composite wood structure of claim 2, wherein the polymeric resin is a cross-linked polymer resin.

4. The composite wood structure of claim 1, wherein the polymeric resin comprises polyurethane.

5. The composite wood structure of claim 1, wherein the wooden body is further infused with a product formed by a reaction between an intermediate and a first monomeric precursor to the polymeric resin, the intermediate being formed as a result of a reaction between a second monomeric precursor to the polymeric resin and a hydroxyl group of a water molecule from the wooden body.

6. The composite wood structure of claim 5, wherein the product has a higher thermal stability than the polymeric resin.

7. The composite wood structure of claim 5, wherein the product is urea.

8. The composite wood structure of claim 1, wherein the wooden body is a piece of lumber having a commercial-grade rating lower than No. 2 or No. 2B prior to being infused with the polymeric resin.

9. The composite wood structure of claim 1, wherein the wooden body is an aggregate of wood particulate.

10. The composite wood structure of claim 9, wherein the wood particulate is woodchips or sawdust.

11. The composite wood structure of claim 1, further comprising a fiber-reinforced polymer.

12. The composite wood structure of claim 11, wherein the composite wood structure has a flexural strength of at least 9,000 pounds per square inch (psi).

13. The composite wood structure of claim 1, wherein the composite wood structure comprises about 5 wt % to about 40 wt % of the polymeric resin, and wherein the commercial-grade rating of the composite wood structure is (i) No. 2 or higher or (ii) No. 2B or higher.

14. A method for fabricating a composite wood structure, comprising:
infusing a wooden body with a polymeric resin; and
curing the resin-infused wooden body;
wherein infusing the wooden body with the polymeric resin reduces the moisture content of the wooden body.

15. The method of claim 14, wherein infusing the wooden body with the polymeric resin includes synthesizing the polymeric resin in situ within the wooden body.

16. The method of claim 15, wherein infusing the wooden body with the polymeric resin includes
mixing a first, monomeric precursor of the polymeric resin with a second precursor of the polymeric resin to form a mixture, the first, monomeric precursor being hydroxyl-reactive, and
applying the mixture to the wooden body under pressure to introduce the first, monomeric precursor and the second precursor of the polymeric resin into the wooden body to promote synthesis of the polymeric resin.

17. The method of claim 16, wherein the first, monomeric precursor of the polymeric resin is an isocyanate.

18. The method of claim 16, wherein the second precursor of the polymeric resin is a polyol.

19. The method of claim 15, wherein the polymeric resin is polyurethane.

20. The method of claim 15, further comprising:
drying the wooden body prior to infusing the polymeric resin, such that the moisture content of the wooden body is greater than 18% following drying;
wherein, subsequent to drying the wooden body, infusing the wooden body with the polymeric resin reduces the moisture content of the wooden body to 8% to 18%.

21. The method of claim 15, wherein, subsequent to infusing the wooden body with the polymeric resin, the resin-infused wooden body is cured under pressure in a heated environment.

22. The method of claim 14, wherein the wooden body is a low-grade wooden body.

23. The method of claim 14, further comprising applying a fiber-reinforced polymer (FRP) to the resin-infused wooden body subsequent to curing the resin-infused wooden body.

24. The method of claim 23, wherein applying the FRP to the resin-infused wooden body includes encapsulating the resin-infused wooden body with the FRP.

25. The method of claim 14, wherein a heterogeneous interpenetrating polymer network (IPN) is formed between the polymeric resin and native polymers of the wooden body.
